(19) United States
(12) Patent Application Publication
(10) Pub. No.: US 2007/0061577 A1
(43) Pub. Date: Mar. 15, 2007

(54) Signal encoding

(76) Inventors: Leon Maria Van De Kerkhof, Eindhoven (NL); Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,290

(22) PCT Filed: Oct. 1, 2004
(86) PCT No.: PCT/IB04/51948

§ 371 Date: Apr. 11, 2006

(30) Foreign Application Priority Data
Oct. 17, 2003 (EP) 03103854.0

(51) Int. Cl. H04L 9/00

(52) U.S. Cl. 713/176

(57) ABSTRACT

The invention relates to a signal encoding system (100). A pre-encoder (103) encodes a signal and generates a pre-encoded signal. In addition the pre-encoder (103) generates encoding assistance data which is stored in a signal storage (105) together with the pre-encoded signal. When the signal is retrieved from the signal storage (105), it is decoded in a decoder (111) and a watermark is inserted in the decoded signal to generate a watermarked signal. The watermarked signal is then re-encoded, possibly at a different encoding rate, in a re-encoder (117). The re-encoder (117) is operable to re-encode the watermarked signal in response to the encoding assistance data. Thus, encoding assistance data may be generated at encoding prior to storage and the encoding assistance data may be used to facilitate re-encoding of a watermarked signal when retrieved. The invention is particular advantageous for applications wherein pre-encoding is performed once whereas re-encoding is frequently performed, such as for example a client-server music download application.

### FIELD OF THE INVENTION

The invention relates to a signal encoding system and a method of encoding a signal and in particular to embedding a watermark in a signal.

### BACKGROUND OF THE INVENTION

The illicit distribution of copyright material deprives the holder of the copyright the legitimate royalties for this material, and could provide the supplier of this illicitly distributed material with gains that encourages continued illicit distributions. In light of the ease of transfer provided by the Internet, content material that is intended to be copyright protected, such as artistic renderings or other material having limited distribution rights are susceptible to wide-scale illicit distribution. The MP3 format for storing and transmitting compressed audio files has made a wide-scale distribution of audio recordings feasible. For instance, a 30 or 40 megabyte digital PCM (Pulse Code Modulation) audio recording of a song can be compressed into a 3 or 4 megabyte MP3 file. Using a typical 56 kbps dial-up connection to the Internet, this MP3 file can be downloaded to a user's computer in a few minutes. This means that a malicious party could provide a direct dial-in service for downloading an MP3 encoded song. The illicit copy of the MP3 encoded song can be subsequently rendered by software or hardware devices or can be decompressed and stored on a recordable CD for playback on a conventional CD player.

A number of techniques have been proposed for limiting the reproduction of copy-protected content material. The Secure Digital Music Initiative (SDMI) and others advocate the use of “digital watermarks” to prevent unauthorised copying.

Digital watermarks can be used for copy protection according to the scenarios mentioned above. However, the use of digital watermarks is not limited to copy prevention but can also be used for so-called forensic tracking, where watermarks are embedded in e.g. files distributed via an Electronic Content Delivery System, and used to track for instance illegally copied content on the Internet. Watermarks can furthermore be used for monitoring broadcast stations (e.g. commercials); or for authentication purposes etc.

Watermarks generally provide the best performance when embedded in the uncompressed signal, and there are several known techniques for embedding watermarks in a raw uncompressed signal.

Patent Cooperation Treaty patent application WO 02/091374 A1 describes a method of watermarking a raw uncompressed audio signal by use of a watermark filter. In this method, the watermark signal is embedded by means of linear filtering of the raw uncompressed signal x[n] by a filter w′[n]:
y[n]=x[n]+α·(x[n]*w′[n]) (1)
where α is a scaling factor corresponding to the embedding strength, y[n] is the watermarked output signal and * denotes the convolution operation. w′[n] represents the impulse response of the watermark filter. Re-ordering the equation yields:
y[n]=x[n]*(1+α·w′[n])=x[n]*w[n] (2)
where w[n]=1+α·w′[n]. This representation shows that the approach of WO 02/091374 is equivalent to filtering the input signal x[n] by the watermark filter w[n].

Techniques have been proposed to apply the watermark embedding directly onto the coded bit stream, but by nature these embedding systems cause artefacts at least in the order of magnitude of the coding artefacts and are thus less suitable for high quality watermark embedding. Further description of bit stream watermarking may be found in PCT Patent Application WO 01/49363 A1 ‘Method and system of digital watermarking for compressed audio Patent’ or in ‘Audio watermarking of MPEG-2 AAC bitstreams’ by Christian Neubauer and J. urgen Herre, 108th AES Convention, Paris, February 2000. Audio Engineering Society. preprint 5101.

In many applications, the application of the watermark may result in an unacceptable or undesirable amount of computational complexity. For example, in many audio server-client architectures, it is desirable that clients obtain individually watermarked and compressed copies of the original signal. This allows tracing content in download and streaming applications. In such an application, each request for a digital audio item results in a watermark being individually embedded followed by compression into a suitable format. In applications where a large number of concurrent requests appear, computational complexity associated with the watermark embedding and audio encoding becomes significant and even unacceptably high.

Furthermore, client service applications where a large number of content items are centrally stored tend to utilise compressed representations for the content items in order to reduce the online storage requirements. For example, a music client server for distributing music may typically store the audio in a compressed format such as MPEG, AAC, WMA, etc.

Thus, in order to utilise a watermark algorithm operating in the non-compressed domain, it is necessary to convert the stored compressed signal into an uncompressed signal, embed the watermark and subsequently convert the signal back to the compressed domain for distribution of the signal.

For example, in order to utilise the filter based watermark approach of WO 02/091374, a stored compressed signal is first converted back into a raw uncompressed signal. A watermark may then be embedded by an operation in accordance with equation (1) or (2) given above and the resulting signal may be converted back into a compressed signal.

However, a number of disadvantages are associated with such an approach. These disadvantages include for example that the process requires an additional decoding and encoding process, where in particular the re-encoding of the watermarked uncompressed signal tends to be complex and resource demanding. Thus the required processes increase the complexity and computational burden substantially. This may for example result in increased cost and/or power consumption. It may further result in additional delays.

Hence, an improved system for signal encoding would be advantageous and in particular a system allowing for reduced complexity, improved quality, reduced power consumption, reduced cost, improved performance and/or reduced delay would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided a signal encoding system comprising: means for receiving a signal; a pre-encoder for pre-encoding the signal to generate a pre-encoded signal; storage means for storing the pre-encoded signal; a watermark processing means comprising a decoder for decoding the pre-encoded signal to generate a decoded signal, a watermark embedder for inserting a watermark in the decoded signal to generate a watermarked signal, a re-encoder for re-encoding the watermarked signal to generate a watermarked encoded signal; and wherein the pre-encoder is operable to generate encoding assistance data and the re-encoder is operable to re-encode the watermarked signal in response to the encoding assistance data.

The invention may facilitate watermark embedding into a signal. Specifically the invention may facilitate embedding a non-compressed domain watermark into a signal which has been stored in a compressed domain and is distributed or communicated in a compressed domain. The invention may specifically achieve reduced complexity and/or computational resource of the overall processing. The invention may additionally or alternatively allow lower cost of signal encoding equipment and/or provide higher capacity. The power consumption and/or delay may furthermore be reduced. In some cases, the quality of the re-encoded watermarked signal may be improved. The invention is particularly advantageous in client-server applications where individual watermarks may be embedded in response to client requests for specific signals.

The signal is preferably an audiovisual signal including for example an audio music signal. For example, the invention may allow a practical and easy to implement system of embedding dedicated watermarks into individual songs stored in the storage means as and when these are requested by clients.

The pre-encoder and re-encoder may preferably but not necessarily use the same or similar encoding standards. Furthermore, the encoding rate of the pre-encoder and re-encoder may be different with preferably the pre-encoding rate being higher than the re-encoding rate. The operations of the signal encoding system are preferably performed using digital signal processing but in some embodiments analogue signal processing may be partially or fully employed. The encoding assistance data may preferably be compatible with the re-encoding process and may obviate, facilitate, enhance or reduce the processing of the re-encoder.

In a client-server application, the pre-encoding may be performed once (or few times) for a signal whereas re-encoding may be performed every time a signal is requested. Hence, any complexity increase of the pre-encoder due to the generation of encoding assistance data will typically be insignificant in view of the complexity decrease of the re-encoding process.

Preferably, all signals are audio signals but other signals including audiovisual signals may be used. The signals may for example correspond to a content item such as a song or audio clip.

According to a feature of the invention, the pre-encoder is operable to include the encoding assistance data in the pre-encoded signal. This may allow an efficient storage, control, management and distribution of the encoding assistance data. It may for example allow the encoding assistance data to automatically be retrieved when the pre-encoded signal is retrieved.

According to a different feature of the invention, the pre-encoder is operable to include the encoding assistance data in at least one ancillary data section of the pre-encoded signal. Many encoding standards comprise ancillary data sections, which comprise data not inherently part of the encoded content signal. Such data sections may provide particularly suitable storage means for the encoding assistance data.

According to a different feature of the invention, the storage means is operable to store the encoding assistance data This allows a practical and efficient implementation.

According to a different feature of the invention, the pre-encoder is operable to generate encoding parameters associated with an encoding data rate different than an encoding rate of the pre-encoded signal and to include the encoding parameters in the encoding assistance data.

This enables or facilitates the encoding assistance data to be used for re-encoding at different encoding rates. Hence, the watermark processing means may also perform a rate conversion. Any additional complexity increase associated with the generation of encoding assistance data at an additional data rate may be acceptable in view of the possible complexity decrease of the re-encoding process.

According to a different feature of the invention, the encoding assistance data comprises encoding quantisation control data. The quantisation control data may determine the distribution of bits, and consequently quantisation noise, over the signal spectrum. For example, in MPEG Layer II, the quantisation is controlled by the bit allocation data, in MP3 and AAC the quantisation is controlled by scale factor data

According to a different feature of the invention, the encoding assistance data comprises encoding scale factor data. This is a particularly advantageous parameter to comprise in the encoding assistance data. Scale factor data may efficiently be re-used at the re-encoder and as scale factor determination typically is one of the most complex operations of an encoding operation, a significant complexity reduction may be achieved. Scale factors may furthermore be suitable for use at different encoding rates.

According to a different feature of the invention, the encoding scale factor data comprises a scale factor offset associated with a scale factor offset value between a first encoding rate and a second encoding rate. Scale factors for different encoding rates may typically be similar or comparable except for an offset. Hence, by only determining and/or storing the scale factor offset for a second encoding rate less encoding assistance data and/or processing is required.

According to a different feature of the invention, the first encoding rate is an encoding rate of the pre-encoded data signal and the second encoding data rate is an encoding data rate of the watermarked encoded signal. According to the feature, an efficient rate conversion may be applied between the pre-encoded signal and the watermarked encoded signal. The re-encoding may be efficient while requiring only little encoding assistance data and a simplified determination of scale factors.

According to a different feature of the invention, the encoding assistance data does not comprise scale factor values. Specifically, the only information related to scale factors in the encoding assistance data may be the scale factor offset (or offsets related to different encoding rates). This may allow reduced processing and particularly reduced storage requirements. In some embodiments, where the ancillary data sections are used to store encoding assistance data, it may allow the encoding assistance data to fit within the limited storage capacity available.

According to a different feature of the invention, the re-encoder is operable to generate the watermarked encoded signal at the second encoding rate by determining re-encoding scale factors in response to the scale factor offset and scale factor values associated with the first encoding rate. For example, the re-encoder may simply determine the scale factors by subtracting the scale factor offset from the existing scale factors of the first encoding rate. Hence, the feature may allow a very simple and low complexity determination of scale factors.

According to a different feature of the invention, the pre-encoder is operable to replace the scale-factors of the pre-encoded signal by a shifted version of the scale-factors of the second encoding rate. This may result in a lower encoded bandwidth, that corresponds to the second encoding rate, for the pre-encoded signal. The re-encoder may determine the exact scale factors corresponding to the second encoding rate, by subtracting the scale factor offset from the scale factors of the pre-encoded signal The feature may improve the quality of the re-encoded signal, particularly in the case where different encoders are used and the difference between the scale factors obtained for the first and second encoding rate are not sufficiently accurately represented by a scale factor offset.

According to a different feature of the invention, the encoding assistance data comprises encoding rate independent encoding parameters that are substantially independent of the encoding rate. The encoding rate independent encoding parameters may for example be substantially identical for a plurality of encoding rates and may be used directly by the encoder thereby reducing complexity of the processing. Encoding rate independent encoding parameters may include Temporal Noise Shaping (TNS) parameters which are e.g. used in the AAC coding standard to improve the temporal distribution of the coding errors due to quantization. Another example of encoding rate independent encoding parameters is window switching parameters which are used in e.g. the AAC and mp3 (MPEG-LIII) coding standards to control the block size that is used in the transform. Long blocks are generally used for pseudo-stationary signals, whereas short blocks are used in the more transient signal intervals.

According to a different feature of the invention, the encoding assistance data comprises a first encoding parameter associated with a first encoding rate and the re-encoder comprises means for determining a first corresponding encoding parameter associated with a second encoding rate in response to the first encoding parameter.

Specifically, the encoding parameter may have a known or predictable variation as a function of the encoding rate. The re-encoder may evaluate this function to determine the value of the encoding parameter suitable for the second encoding data rate. The feature may allow facilitated re-encoding.

According to a different feature of the invention, the encoding assistance data comprises perceptual model data. The perceptual model data may typically be relatively independent of the encoding rate and may be particularly suitable for use in re-encoding at a different data rate. The format of this perceptual model data may preferably be targeted to the format that is best suited for the watermark embedding and/or re-encoding process. Only perceptual model data of a limited bandwidth may be used. Furthermore, the perceptual data may be converted into critical bands that match with the watermark embedding which are not necessarily identical to those of the re-encoder.

According to a different feature of the invention, the re-encoder is operable to operate frame aligned with the pre-encoder. This may allow a particularly practical implementation and may specifically allow each frame to be processed individually and/or independently.

Preferably, the signal is an audio signal or video signal and the pre-encoded signal is preferably pre-encoded in accordance with an MPEG audio and/or video compression standard. The MPEG audio compression standard may for example be an MPEG-encoding standard and may specifically be the Advanced Audio Coding (AAC) standard.

According to a different feature of the invention, there is provided a signal distribution system comprising a signal encoding system as described above wherein the pre-encoder is operable to pre-encode a multiplicity of signals; the storage means is operable to store the multiplicity of signals and the watermark processing means is operable to individually embed a watermark in a plurality of signals, and further comprising means for distributing the plurality of signals.

The invention may thus facilitate or enable efficient individual embedding of a watermark in a plurality of signals. The watermarks embedded in each signal are preferably different. The means for distributing may specifically be means for interfacing to an external distribution medium such as for example the Internet. The feature is particularly suited for a client-server application wherein a central server stores a larger number of content item signals that may be individually requested by a number of clients.

According to a second aspect of the invention, there is provided a method of encoding a signal comprising the steps of: receiving a signal; pre-encoding the signal to generate a pre-encoded signal; generate encoding assistance data in association with the pre-encoding; storing the pre-encoded signal; decoding the pre-encoded signal to generate a decoded signal; inserting a watermark in the decoded signal to generate a watermarked signal; and re-encoding the watermarked signal to generate a watermarked encoded signal in response to the encoding assistance data.

According to a third aspect of the invention, there is provided a signal encoding system (100) comprising: means (101) for receiving a signal; a pre-encoder (103) for pre-encoding the signal to generate a pre-encoded signal at a first encoding rate and operable to generate encoding assistance data comprising scale factor offset data indicative of an association between at least one scale factor associated with the first encoding rate and at least one scale factor associated with a second encoding rate different than the first encoding rate; and a re-encoder (117) operable to re-encode the signal or the pre-encoded signal at the second encoding rate in response to the scale factor offset data of the encoding assistance data.

This may allow for an efficient re-encoding based on encoding assistance data. The determination of scale factors for the second encoding rate may require low complexity and computational resources and a reduced amount of encoding assistance data may be required.

According to a fourth aspect of the invention, there is provided a method of encoding a signal comprising the steps of: receiving a signal; pre-encoding the signal to generate a pre-encoded signal at a first encoding rate; generating encoding assistance data comprising scale factor offset data indicative of an association between at least one scale factor associated with the first encoding rate and at least one scale factor associated with a second encoding rate different than the first encoding rate; and re-encoding the signal or the pre-encoded signal at the second encoding rate in response to the scale factor offset data of the encoding assistance data.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates a signal encoding system in accordance with an embodiment of the invention; and

FIG. 2 illustrates an example of scale factors for different encoding rates.

### DESCRIPTION OF PREFERRED EMBODIMENTS

The following description focuses on an embodiment of the invention applicable to an audio client server application allowing for access to a central store of audio content items. However, it will be appreciated that the invention is not limited to this application but may be applied to many other signal encoding applications. The embodiment will further be described by reference to an example encoding standard, Advanced Audio Coding (AAC), but it will be apparent that the invention is equally applicable to many other encoding standards.

Audio download services are increasing in popularity. At the server side, a database covering a wide variety of songs is available to the subscribers. In an offline pre-encoding stage, different business models are in use. In the more sophisticated audio download services, clients may obtain individually watermarked copies of the compressed audio content items. This caters for individual tracing of content in download and streaming applications (forensic tracking).

In such an application, a watermark is added to a content item in the uncompressed domain in response to a request for the content item. The content item is subsequently encoded. To save on-line storage space, the database is often encoded in a lossy compressed format, such as AAC (Advanced Audio Coding). Consequently, the content needs to be decoded prior to adding a watermark and the resulting signal is re-encoded for distribution.

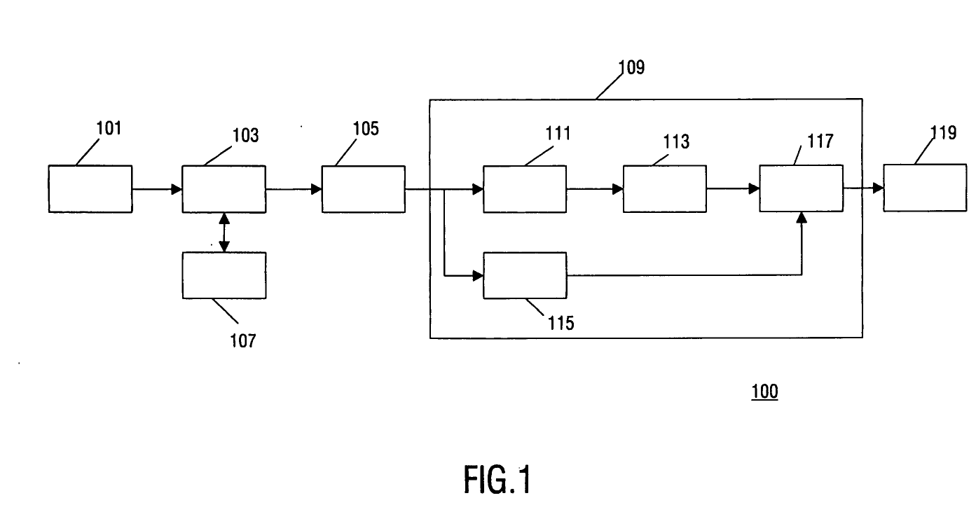

FIG. 1 illustrates a signal encoding system 100 in accordance with an embodiment of the invention. The example embodiment comprises a client-server download application wherein clients may retrieve audio content from a central server.

The signal encoding system 100 comprises a receiver 101 which is operable to receive an audio signal from a source (not shown). The source may be an external source or may be an internal source such as a removable storage medium (e.g. a compact disc). The receiver 101 receives the audio signal in a suitable format which in the described embodiment is a digital Pulse Code Modulated (PCM) signal.

The receiver is coupled to a pre-encoder 103 which is operable to encode the audio signal into a suitable pre-encoded signal. In the described embodiment, the pre-encoder performs an AAC encoding of the received PCM signal, thus generating an AAC pre-encoded signal having a suitable encoding rate. The pre-encoder 103 is coupled to a signal storage 105 and is operable to store the pre-encoded signal in the signal storage 105. In the specific embodiment, the pre-encoder 103 may pre-encode a large number of songs and store each of these individually in the signal storage 105.

The pre-encoder 103 is furthermore coupled to an encoding assistance data processor 107. The encoding assistance data processor 107 is operable to generate encoding assistance data which may facilitate or assist in a subsequent encoding or re-encoding of the pre-encoded signal. In the described embodiment, the encoding assistance data predominantly relates to encoding of signals according to the same encoding standard as used by the pre-encoder 103 but in other embodiments other encoding standards may be employed and the encoding assistance data may relate to this standard or may be fully or partially standards independent. In the described embodiment, the encoding assistance data processor 107 generates encoding assistance data for all content items being pre-encoded by the pre-encoder 103.

In FIG. 1, the encoding assistance data processor 107 is illustrated as a separate functional module but it will be appreciated that it may be practical to implement the pre-encoder 103 and the encoding assistance data processor 107 together. For example, conceptually the pre-encoder 103 may be executed twice, once for the pre-encoding data rate (of say 192 kbit/s) and one for a subsequent encoding rate (of say 96 kbit/s). However, for most of the computationally intensive modules, the result is independent of the bit-rate and only a rate distortion module may practically be executed twice, once for each bit-rate. The encoding assistance data generated by the encoding assistance data processor 107 may specifically comprise parameters obtained by encoding at the subsequent encoding rate (of 96 kbit/s.) For AAC, these parameters may for example comprise scale-factors, section-data and pulse-data. In the described embodiment, the entire pre-encoded database is created according to this procedure.

The signal storage 105 is coupled to a watermark processing unit 109. The watermark processing unit 109 comprises a decoder 111 coupled to the signal storage 105 and operable to decode a retrieved pre-encoded signal. The decoder 111 is coupled to a watermark embedder 113 and is operable to feed the decoded signal thereto. The watermark embedder 113 is operable to embed a watermark into the decoded signal in accordance with any suitable algorithm. For example, the watermark embedder 113 may be operable to embed a watermark into the decoded signal in accordance with the algorithm described in Patent Cooperation Treaty patent application WO 02/091374 A1. Hence, in accordance with the described embodiment, the pre-encoded signal may for example be a compressed signal while the decoded signal may be a non-compressed signal. Thus, the embodiment allows an efficient storage of a compressed signal combined with an efficient watermark embedding in the non-compressed domain.

The watermark embedder 113 is coupled to a re-encoder 117 which is operable to re-encode the watermarked signal to generate a watermarked encoded signal. The watermarked encoded signal is preferably a compressed encoded signal and is typically compressed to a lower encoding rate than the encoding rate of the pre-encoded signal.

The watermark processing unit further comprises an encoding assistance data retriever 115 which is coupled to the signal storage 105. The encoding assistance data retriever 115 is operable to retrieve the encoding assistance data associated with the content item currently being watermarked. In some embodiments, the decoder 111 may automatically retrieve both the pre-encoded signal and the encoding assistance data and in some embodiments the encoding assistance data retriever 115 may be coupled to the decoder 111 rather than the signal storage 105. The latter will typically be the case when the assistance data is conveyed in the ancillary data portion of the bit stream.

The encoding assistance data retriever 115 is further coupled to the re-encoder 117 and is operable to feed the encoding assistance data to this. The re-encoder 117 is operable to re-encode the watermarked signal using some or all of the information comprised in the encoding assistance data This may substantially improve subjective quality and facilitate and reduce the processing and complexity required by the re-encoding process and thereby substantially reduce the complexity and increase the capacity of the watermark processing unit 109.

The re-encoder 117 is coupled to a distribution processor 119 which is operable to distribute the watermarked encoded signal to one or more clients. In the described embodiment, the distribution processor 1 19 comprises an interface to the Internet thereby enabling distribution of the content items through existing non-dedicated means.

Thus, in the described embodiment, a content item is requested, the pre-encoded bit-stream of the content item is decoded and the content is watermarked. In the re-encoding stage the watermarked content is encoded using the encoding assistance data such as scale-factors, section-data and pulse data. Other encoding assistance data, including e.g. information such as TNS and block-switching data, is copied directly from the pre-encoded signal bit-stream. As a result, the re-encoder may only need to perform the quantization and coding based on the available code-book information that is conveyed in the section data. It is possible that, because of the watermarking, a scaled spectral coefficient does not fit in the pre-selected code-book. In that case clipping may be performed to the boundary of the code-book. It has been experimentally verified that this clipping occurs in less than 0.1% of the cases and does not negatively affect the perceived audio quality.

It will be appreciated that a practical application may comprise further functionality for receiving requests from clients, distributing the content items to the client, managing and creating a collection of content items in the signal storage etc. However, the implementation of this functionality is well known to the person skilled in the art and will for clarity and brevity not be described further herein.

Preferably, the encoding assistance data is not stored separately in the signal storage 105 but is included in the pre-encoded signal itself. Many encoding standards allow additional data which is not directly required for decoding of the signal to be included. Thus many encoding standards allow an encoded signal to comprise ancillary data sections wherein additional data may be comprised. For example, AAC allows data to be comprised in ancillary data sections known as Data Stream Elements (DSE) or Fill Elements (FIL). By storing the encoding assistance data in the pre-encoded signal itself, the encoding assistance data may automatically be stored, retrieved and distributed with the pre-encoded signal thereby facilitating operations.

The re-encoder 117 is in the described embodiment operable to generate encoding parameters from the encoding assistance data that may be used in the re-encoding of the watermarked signal. In the described embodiment, the encoding rate of the pre-encoded signal and the watermarked encoded signal are different and specifically the encoding rate of the re-encoder 117 is lower than the encoding rate of the pre-encoded signal. Thus for example, a 192 kbps pre-encoded signal is re-encoded at 96 kbps. In some embodiments, the encoding rate of the re-encoder 117 may vary and may specifically be changed for each content item e.g. in response to a request by a user.

The re-encoder 117 is operable to process data of the encoding assistance data to make it suitable for the encoding rate employed. In some embodiments, the encoding assistance data may comprise encoding parameters related to different data rates and the re-encoder 117 may simply select and use the encoding parameters that are appropriate for the current encoding rate. Experimentally, it has been found that for optimal detectability of the audio watermark, the pre-encoded AAC bit-rate is preferably higher than the re-encoded bit-rate.

Specifically, some encoding parameters may be substantially independent of the encoding rate, and the re-encoder 117 may use these parameters directly. In some cases, these encoding parameters may be inherently included in the pre-encoded signal (rather than separately or in ancillary data sections) and may be extracted directly from the pre-encoded signal and used in the re-encoding process.

An example of such a parameter is the band-width of scale-factors. For a higher encoding rate, it is possible that a higher number of scale-factors are encoded. In that case, the scale-factors for the higher encoding rate may be encoded up to the scale-factor index that is obtained for the lower bit-rate. Other examples of such parameters are TNS and the block-switching parameter of the AAC encoding standard.

In some embodiments, the pre-encoder 103 is operable to generate encoding data related to other encoding rates than the encoding rate of the pre-encoded signal. For example, the pre-encoder 103 may generate encoding parameters such as scale factors, section data and pulse data at a second encoding rate. These encoding parameters may be included in the encoding assistance data and stored in the ancillary data sections of the pre-encoded signal and subsequently used in the re-encoding.

Additionally or alternatively, the encoding assistance data may comprise encoding parameters which are not directly derived for or applicable to the re-encoding rate but which may be processed to derive encoding parameters that can be used by the re-encoder 117. For example, some encoding parameters may have a predetermined or pre-evaluated relationship with the encoding rate. Specifically, the variation of some encoding parameters as a function of encoding rate may be accurately or approximately known, and this function may be applied to the encoding parameters of the encoding assistance data to find suitable values for the encoding rate of the re-encoder 117.

Specific examples of encoding parameters include section data prescribing which codebooks are used for which scale-factor bands. As will be appreciated by the person skilled in the art, a codebook may be used to translate a scaled and quantized spectral coefficient to a variable length Huffman code word.

Another example is pulse-data which is used to represent outliers in spectral coefficients. In the case of high dynamics in spectral data, it may be beneficial to extract single spectral components such that a lower complexity code book can be employed. The pulse data describes the position and amplitude of these extracted components.

As another example, the encoding assistance data may comprise encoding scale factor data. As will be appreciated by the person skilled in the art, scale-factors are used to scale the spectral data prior to quantization. The more the spectral coefficients are reduced in amplitude the coarser the quantization. Typically there exists one scale-factor per scale-factor band per frame. Scale-factor bands represent a group of cosine transform coefficients with a width that roughly corresponds to critical bands.

In some embodiments, scale factors associated with the encoding rate of the re-encoder 117 may be determined by the pre-encoder 103 and stored as encoding assistance data.

However, preferably, the encoding assistance data does not comprise specific scale factors but rather comprises a scale factor offset value which may be applied to the scale factors of the pre-encoded signal to generate scale factors at a different encoding rate. For example, the re-encoder 117 may in this embodiment simply generate scale factors for a second encoding rate by extracting the scale factors of the pre-encoded signal and offsetting these by the scale factor offset value of the encoding assistance data.

As a specific example, in AAC encoding, scale-factors are employed to scale the spectral data to a range suitable for quantization by a quantizer. The scale-factor directly controls the quantization error. A scale-factor is calculated per scale-factor band. The bandwidths of the scale-factor bands correspond to a large extent to critical bands. The shape of the scale-factors curve is mainly determined by the spectral signal energy and the masked threshold. The offset of the scale-factors curve is mainly determined by the encoding rate. When coding a signal at two encoding rates with the same encoder, the shape of the scale-factors curve will typically be comparable. Larger deviations in scale-factors can occur if different encoders are used. The offset and, depending on the difference between the encoding rates, the number of active (non-zero) scale-factors will be different for the different encoding rates.

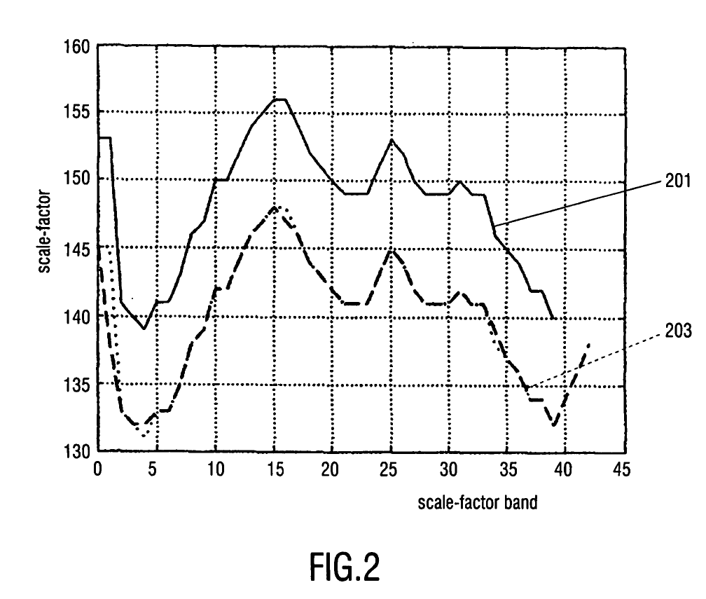

FIG. 2 illustrates an example of scale factors for different encoding rates. Specifically, FIG. 2 illustrates an example of scale factors for a 64 kbit/s AAC encoded signal 201 and a 128 kbit/s AAC encoded signal 203. As can be seen, the shift in scale-factors is fairly constant across the frequency spectrum. Also it may be noted that the number of scale factors obtained for 128 kbit/s is higher than that obtained for 64 kbit/s. This is due to the higher encoded bandwidth that is obtained for a higher bit-rate.

Scale-factors are for AAC differentially encoded relative to the first non-zero scale-factor that is referenced to as ‘global_gain’. Typically, for an encoding bit-rate of 64 kbit/s, scale-factor data require a data rate of about 6 kbit/s. This can be reduced to only a few kbit/s by differentially coding the scale-factors. For further bit-rate reduction, the scale-factors of the pre-encoded signal may be replaced by a shifted version of the scale-factors of the lower encoding rate. The offset corresponds to the overall offset between the scale-factor curves associated with the bit-streams. Thus, in this embodiment, the decoder of the watermark processing unit retrieves the scale factors and offsets these by the scale factor offset of the encoding assistance data before decoding the pre-encoded signal. The re-encoder may directly retrieve the scale factors of the pre-encoded signal and use these for the re-encoding.

It will be appreciated by the person skilled in the art that encoding assistance data using a scale factor offset may be used for re-encoding regardless of whether watermark embedding has been performed or not.

Preferably, the pre-encoder, the decoder and the re-encoder operates frame aligned. The addition of the watermark will result in very small modifications of the spectral coefficients and therefore re-quantizing these values will result in substantially the same spectral coefficients after decoding. It should therefore be noted that for successful addition of a watermark with sufficient robustness, the encoding rate used to represent the spectral coefficients in the signal storage is preferably higher than the rate after re-encoding.

The invention can be implemented in any suitable form including hardware, software, firmware or any combination of these. However, preferably, the invention is implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A signal encoding system (100) comprising:
means (101) for receiving a signal;
a pre-encoder (103) for pre-encoding the signal to generate a pre-encoded signal;
a watermark processing means (109) comprising:
a decoder (111) for decoding the pre-encoded signal to generate a decoded signal,
a watermark embedder (113) for inserting a watermark in the decoded signal to generate a watermarked signal,
a re-encoder (117) for re-encoding the watermarked signal to generate a watermarked encoded signal; and
wherein the pre-encoder (103) is operable to generate encoding assistance data and the re-encoder (117) is operable to re-encode the watermarked signal in response to the encoding assistance data.

2. A signal encoding system as claimed in claim 1 wherein the pre-encoder (103) is operable to include the encoding assistance data in the pre-encoded signal.

3. A signal encoding system as claimed in claim 2 wherein the pre-encoder (103) is operable to include the encoding assistance data in at least one ancillary data section of the pre-encoded signal.

4. A signal encoding system as claimed in claim 1 further comprising storage means (105) for storing the pre-encoded signal.

5. A signal encoding system as claimed in claim 4 wherein the storage means (105) is operable to store the encoding assistance data.

6. A signal encoding system as claimed in claim 1 wherein the pre-encoder (103) is operable to generate encoding parameters associated with an encoding data rate different than an encoding rate of the pre-encoded signal and to include the encoding parameters in the encoding assistance data.

7. A signal encoding system as claimed in claim 1 wherein the encoding assistance data comprises encoding quantisation control data

8. A signal encoding system as claimed in claim 1 wherein the encoding assistance data comprises encoding scale factor data.

9. A signal encoding system as claimed in claim 8 wherein the encoding scale factor data comprises a scale factor offset associated with a scale factor offset value between a first encoding rate and a second encoding rate.

10. A signal encoding system as claimed in claim 9 wherein the first encoding rate is an encoding rate of the pre-encoded data signal and the second encoding data rate is an encoding rate of the watermarked encoded signal.

11. A signal encoding system as claimed in claim 9 wherein the encoding assistance data does not comprise scale factor values.

12. A signal encoding system as claimed in claim 9 wherein the re-encoder is operable to generate the watermarked encoded signal at the second encoding rate by determining re-encoding scale factors in response to the scale factor offset and scale factor values associated with the first encoding rate.

13. A signal encoding system as claimed in claim 9 wherein the pre-encoder is operable to replace the scale-factors of the pre-encoded signal by a shifted version of the scale-factors of the second encoding rate.

14. A signal encoding system as claimed in claim 1 wherein the encoding assistance data comprises encoding rate independent encoding parameters that are substantially independent of the encoding rate.

15. A signal encoding system as claimed in claim 1 wherein the encoding assistance data comprises a first encoding parameter associated with a first encoding rate, and the re-encoder comprises means for determining a first corresponding encoding parameter associated with a second encoding rate in response to the first encoding parameter.

16. A signal encoding system as claimed in claim 1 wherein the encoding assistance data comprises perceptual model data.

17. A signal encoding system as claimed in claim 1 wherein the re-encoder (117) is operable to operate frame aligned with the pre-encoder (103).

18. A signal encoding system as claimed in claim 1 wherein the signal is an audio signal.

19. A signal encoding system as claimed in claim 18 wherein the pre-encoded signal is pre-encoded in accordance with an MPEG audio compression standard.

20. A signal encoding system as claimed in claim 1 wherein the signal is a video signal.

21. A signal distribution system comprising a signal encoding system as claimed in claim 4 and wherein the pre-encoder (103) is operable to pre-encode a multiplicity of signals; the storage means (105) is operable to store the multiplicity of signals and the watermark processing means (109) is operable to individually embed a watermark in a plurality of signals, and further comprising means (119) for distributing the plurality of signals.

22. A method of encoding a signal comprising the steps of:
receiving a signal;
pre-encoding the signal to generate a pre-encoded signal;
generate encoding assistance data in association with the pre-encoding;
decoding the pre-encoded signal to generate a decoded signal;
inserting a watermark in the decoded signal to generate a watermarked signal; and
re-encoding the watermarked signal to generate a watermarked encoded signal in response to the encoding assistance data.

23. A signal encoding system (100) comprising:
means (101) for receiving a signal;
a pre-encoder (103) for pre-encoding the signal to generate a pre-encoded signal at a first encoding rate and operable to generate encoding assistance data comprising scale factor offset data indicative of an association between at least one scale factor associated with the first encoding rate and at least one scale factor associated with a second encoding rate different than the first encoding rate; and
a re-encoder (117) operable to re-encode the pre-encoded signal at the second encoding rate in response to the scale factor offset data of the encoding assistance data.

24. A signal encoding system as claimed in claim 23 wherein the pre-encoder (103) is operable to include the encoding assistance data in the pre-encoded signal.

25. A signal encoding system as claimed in claim 23 wherein the pre-encoder is operable to replace the scale-factors of the pre-encoded signal by a shifted version of the scale-factors of the second encoding rate

26. A method of encoding a signal comprising the steps of:
receiving a signal;
pre-encoding the signal to generate a pre-encoded signal at a first encoding rate;
generating encoding assistance data comprising scale factor offset data indicative of an association between at least one scale factor associated with the first encoding rate and at least one scale factor associated with a second encoding rate different than the first encoding rate; and
re-encoding the signal or the pre-encoded signal at the second encoding rate in response to the scale factor offset data of the encoding assistance data.

27. A computer program enabling the carrying out of a method according to claim 22.

28. A record carrier comprising a computer program as claimed in claim 27.
